(19) United States
(12) Patent Application Publication
(10) Pub. No.: US 2011/0247310 A1
(43) Pub. Date: Oct. 13, 2011

(54) EXHAUST GAS TREATMENT DEVICE FOR AN EXHAUST GAS SYSTEM AND METHOD OF MANUFACTURING AN EXHAUST GAS TREATMENT DEVICE

(76) Inventors: Wolfgang Hahnl, Grimma (DE); Stefan Hackenberg, Den Haag (DE); Hans-Christoph Hossfeld, Westendorf (DE)

(21) Appl. No.: 12/669,193

(22) PCT Filed: Jul. 10, 2008
(86) PCT No.: PCT/EP2008/005634

§ 371 Date: Feb. 10, 2011

(30) Foreign Application Priority Data
Jul. 16, 2007 (DE) 10 2007 032 982.4

(51) Int. Cl. B01D 46/24; B23P 11/00

(52) U.S. Cl. 55/498; 55/490; 29/428

(57) ABSTRACT

An exhaust gas treatment device for an exhaust system has a housing with an inlet and an outlet. At least one hollow body, which is configured to be gas permeable is arranged in the flow path from the inlet to the outlet. The hollow body is formed of at least one basic element made from a porous substrate. Each basic element includes at least two connecting regions, and two connecting regions each of one or different basic elements overlaps in the region of a connection to form the hollow body. The connecting regions to be connected are pressed with each other to form the hollow body.

### RELATED APPLICATION

This application is the U.S. national phase of PCT/EP2008/005634, filed Jul. 10, 2008, which claims priority to DE 10 2007 032 982.4, filed Jul. 16, 2007.

### BACKGROUND OF THE INVENTION

The present invention relates to an exhaust gas treatment device for an exhaust system, in particular for an internal combustion engine, e.g. of a vehicle.

Particulate filters for diesel exhaust gases are known in which the exhaust gases containing particulates flow through a hollow body made from a porous substrate having a pore size that is selected such that the soot particles are deposited on the porous substrate. Sheets made from metal foam are a preferred substrate for manufacturing these hollow bodies. When the sheets are assembled to form the hollow body, it is important to prevent any gas leaks from being produced between individual segments through which exhaust gas loaded with particulates can flow unfiltered, since this would run contrary to the purpose of the filter.

The object of the invention is to provide an exhaust gas treatment device in which any gaps between sheet edges of a porous substrate can be avoided in a simple way.

### SUMMARY OF THE INVENTION

An exhaust gas treatment device for an exhaust system includes a housing with an inlet and an outlet, and at least one hollow body which is configured to be gas permeable and is arranged in the flow path from the inlet to the outlet. The hollow body is formed of at least one basic element made from a porous substrate. Each basic element includes at least two connecting regions, and provision is made such that two connecting regions, each of one or different basic elements, overlap in the region of a connection to form the hollow body. The overlap of the connecting regions of neighboring sections of the basic elements ensures that no leak is produced to allow exhaust gas to pass through the hollow body unfiltered. This configuration ensures freedom from leakage in a simple manner because only the sizes of blanks of the individual basic elements need to be selected to be appropriately large. Connecting regions of one single (bent) basic element as well as connecting regions of neighboring, separate basic elements can be connected here.

For the porous substrate, for example a metal foam, a metal sponge, a metallic hollow sphere structure or, generally, a porous metal may be utilized. In such materials, the metal forms a lattice structure or a cell structure having a pore size in the range of a few micrometers up to several millimeters, with typically 80% or more of the material being formed by cavities. Metal foams of this type are produced, for example, by expansion of a molten metal, sintering of suitable metal powders, or by heating metal powders provided with suitable blowing agents. Metal sponges may be produced, for example, in a sintering process on the basis of precursor foams made from a plastic material and treated with a metal powder.

As an alternative, non-woven mats made, e.g., from fibers of a ceramic material or silicon carbide, are also suitable for use as the porous substrate.

For producing the connection between the individual connecting regions, the connecting regions are preferably pressed and connected with each other by surface structures of the substrate, e.g. the edges of open pores or loose fiber sections in the region of the surface, engaging each other. The porous substrate in both connecting regions acts similar to a hook-and-loop fastener when two connecting regions are placed flat, one on top of the other, and pressed against each other. The surface structures of one connecting region penetrate into the surface of the respective other connecting region and the surface structures get caught in one another. In this way, a connection is produced over an area along the entire overlap of the two connecting regions, ensuring that no gaps remain that allow exhaust gas to pass through the connection unfiltered.

It is possible to fix the connecting regions to each other exclusively by the surface structures of the basic element or elements engaging each other, by exploiting only the hook-and-loop fastener effect of the substrate. The fastening effect can be defined, above all, by selecting the surface area of the region of overlap.

Alternatively, however, the connecting regions may also be fixed to each other by clamping or sewing or by any other suitable attachment. In this case, the freedom from leakage is still achieved by the connecting regions overlapping and engaging each other. However, the fixing of the connecting regions to each other is supported by further measures, so that the connecting regions can not become detached from one another during operation.

It is possible to manufacture the hollow body from a plurality of basic elements which are connected with each other in neighboring connecting regions by pressing.

The overall length of the basic elements is preferably selected to be longer than the periphery of the hollow body, and the basic elements are rolled up in the nature of a helix, so that the hollow body has a multilayer wall.

The individual basic elements may have different gas permeabilities, densities and/or porosities. Also, they need not have the same length.

The connecting regions may be formed both on the edges of the basic element or elements and on the surface of a basic element. The latter is of advantage if the hollow body has a helically wound, multilayer wall. Preferably, in this case a connecting region located on the edge is pressed with a connecting region located on the surface for closing the hollow body.

In a preferred embodiment, the hollow body includes a basic element or a group of basic elements bent to form a cone or a truncated cone. In this case, a flat blank is rolled up to form a cone or truncated cone. For closing, for example, the connecting regions of the same basic element are connected with each other. Another way of closing the hollow body consists in that a connecting region located on the edge is connected with a connecting region on the surface of the hollow body already formed.

It is possible to produce, e.g., two hollow bodies of this type and to fit the finished cones or truncated cones inversely into each other, in order to make the surface through which gas flows as large as possible in the housing.

If the basic element has a thickness of from approx. 1 to 10 mm, and particularly preferably of from 1 to 3 mm, the substrate sheet is well suitable to be rolled up to form a hollow body in spite of the brittleness of the material.

With such a thickness, the pressing for fastening the connecting regions to each other also works very well.

For fastening the entire hollow body inside the housing, the same technique may be employed as is applied to connect the basic elements among each other. In particular, the hollow body can be fixed to a frame arranged in the housing by an interaction of the structure of the metal foam with the surface of the frame.

A method of manufacturing an exhaust gas treatment device, more particularly having the features mentioned above, includes the following steps: providing a basic element or a group of basic elements made from a porous substrate, with each basic element including at least two connecting regions; superposing two connecting regions, to be connected, of one or more basic elements; and pressing the connecting regions, to be connected, with each other to form the hollow body.

During pressing, the edges of the substrate of two respective connecting regions can get caught in each other.

Preferably, the pressing is performed while the resulting hollow body is bent into its desired shape.

As already explained in more detail above, this procedure constitutes a fast, simple and low-cost way to form the hollow body of an exhaust gas purification device.

Here, the basic element for the group of basic elements is cut to size, for example, in the shape of a developed cone envelope or developed truncated cone envelope. The blank is rolled up to form a cone or truncated cone, with the connecting regions of the blank overlapping. These overlapping connecting regions are pressed with each other.

These and other features of the present invention can be best understood from the following specification and drawings, the following of which is a brief description.

### BRIEF DESCRIPTION OF THE DRAWINGS

Further features and advantages of the invention will be apparent from the following description of an exemplary embodiment in conjunction with the accompanying drawings, in which:

FIG. 1 shows a schematic sectional view of an exhaust gas treatment device according to the invention;

FIG. 2 shows the form of a blank for a basic element of an exhaust gas treatment device according to the invention;

FIG. 3 shows a schematic view of a section taken through a hollow body of an exhaust gas treatment device according to a first variant of the invention;

FIG. 4 shows a schematic section taken through a hollow body of an exhaust gas treatment device according to a second variant of the invention;

FIG. 5 shows a schematic top view of a hollow body of an exhaust gas treatment device according to the invention;

FIG. 6 shows a schematic view of a basic element;

FIG. 7 schematically shows a basic element with different variants of a connecting region; and

FIG. 8 shows a schematic view of a multilayer wall section of the hollow body in FIG. 3.

### DETAILED DESCRIPTION OF THE PREFERRED EMBODIMENT

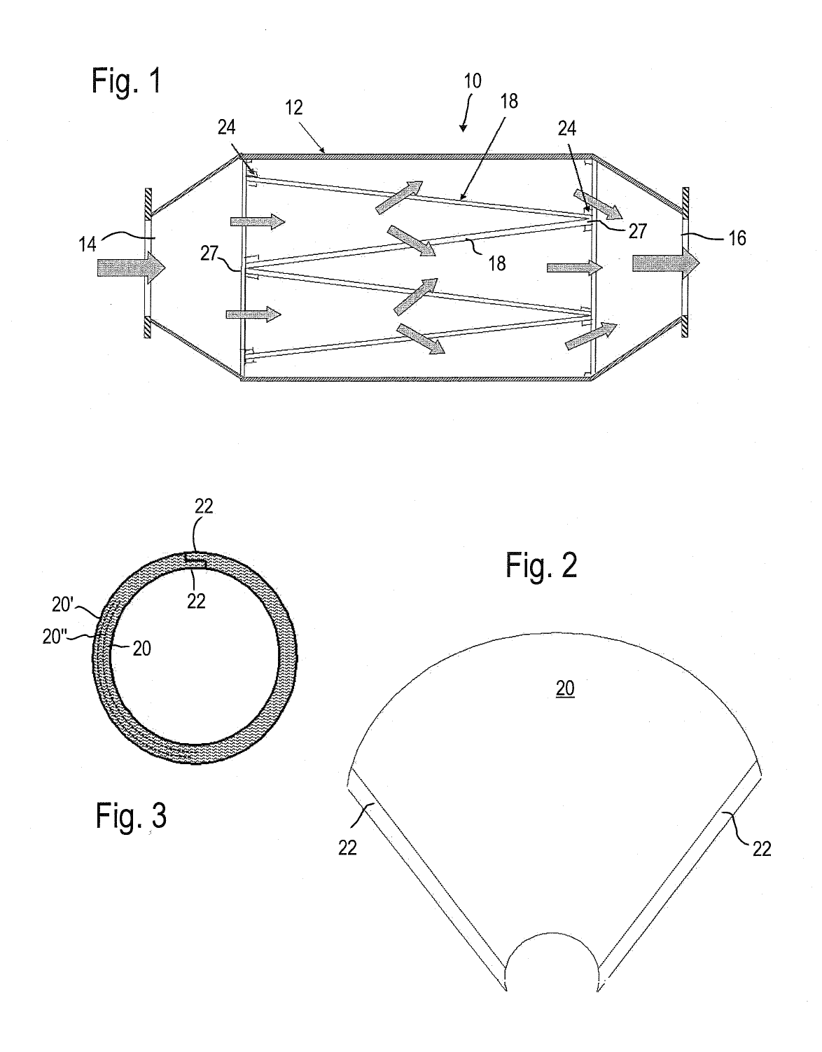

FIG. 1 shows an exhaust gas treatment device 10 for an exhaust system, e.g. that of a diesel internal combustion engine, which has a housing 12 with an inlet 14 and an outlet 16. The housing 12 is formed by a rigid metal body. The exhaust gas treatment device 10 is situated in the exhaust gas flow, which is illustrated by the arrows in FIG. 1. Two gas permeable hollow bodies 18 are arranged in the flow path from the inlet 14 to the outlet 16 in such a way that the exhaust gas must always flow through at least one wall of one of the hollow bodies 18 in order to pass through the exhaust gas treatment device 10.

The exhaust gas treatment device 10 is, e.g., a particulate filter in which soot particles are filtered out from the exhaust gas.

Each of the hollow bodies 18 is formed from one or more basic elements 20, 20′, 20″ using a blank from a porous substrate, in the present case from a metal foam sheet. The term “metal foam” has been adopted into general linguistic usage in expert circles for all kinds of porous metals, irrespective of whether foams having a cellular structure with open or closed pores, are actually involved in a physically correct sense, or whether the material rather exhibits a sponge structure with a grid of webs. Even structures made from sintered microspheres are referred to as “metal foam” within this meaning. In the present example, the metal foam sheets are sheets made from a metal sponge; however, other types of “metal foams” could also be used.

The metal foam sheets have a thickness of from 1 to 10 mm and preferably of from 1 to 3 mm.

In the configuration shown in FIG. 2, the basic element 20 has the shape of a developed truncated cone envelope, which is adapted to be rolled up to form a truncated cone. The included angle of the blank is, for example, 30-45°. The entire straight sides of the basic element 20 each form a connecting region 22 which extends over a few centimeters into the surface of the basic element 20. In this condition, the subdivision is of a purely imaginary nature; the composition of the substrate in the connecting regions 22 does not differ from that of the rest of the substrate of the basic element 20.

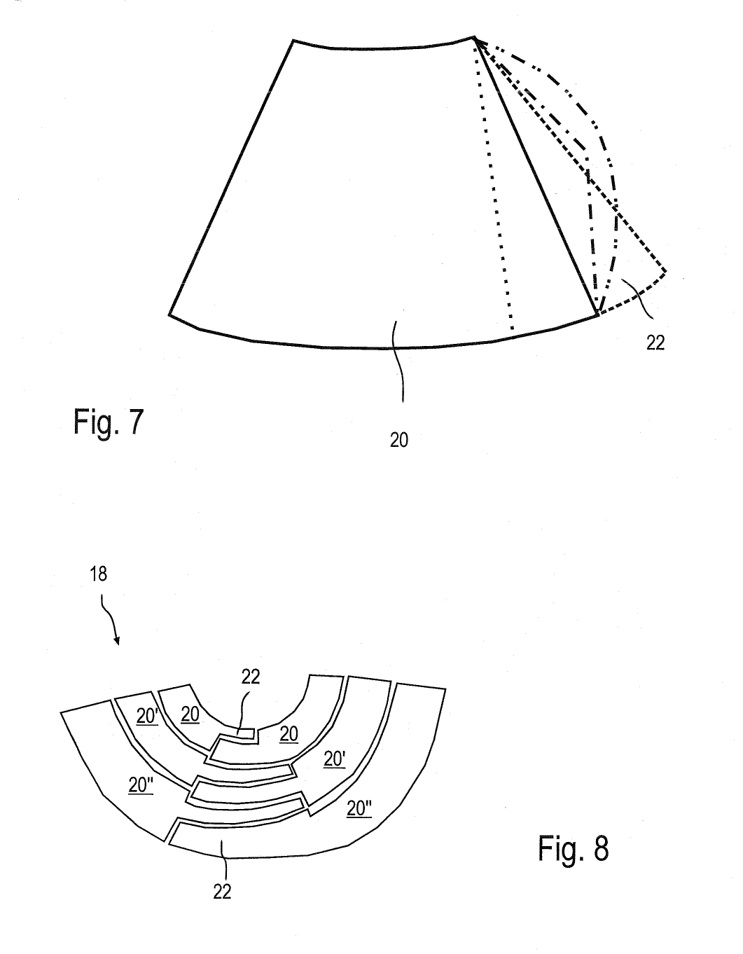

FIG. 7 shows different variants for the configuration of a connecting region situated on the edge of the basic element, illustrated in different types of broken lines. In the basic element 20 shown, which is in the form of a development of a truncated cone, the connecting region 22 is, for example, lengthened in the region of the longer base (dashed) or the shorter base (dotted) or bulged in the middle of the straight side (shown by the two dash-dotted lines). Each of these configurations makes sure that the connecting line does not coincide with the bending line and, in places, results in a larger overlap with the respective edge region to be connected. This counteracts a bulging of the hollow body 18 in the exhaust gas stream.

The substrate of the basic element 20 is, in sections, provided with a coating 23, which is in the form of, e.g., a so-called “washcoat” provided with a catalyst material. The coating 23 leaves the edge regions of the basic element 20 free, in particular the connecting regions 22 and the regions 29 which later serve for fastening in the housing 12 at the ends 27 of the hollow body 18. Especially the regions 29 do not play a part in the exhaust gas treatment, so that an application of catalyst material may be dispensed with at these places. It is also possible to provide only one or some or all of the connecting regions 22 with a coating.

The basic element 20 is now rolled up to form a truncated cone, so that the connecting regions 22 overlap, as is illustrated in FIG. 3. After, or while the overlapping connecting regions 22 are placed one on top of the other, they are pressed with each other along their entire length and width, with the surface structures, in this case the webs at the pore edges of the connecting regions 22, penetrating into the respective other connecting region 22 and getting caught there in the surface structures of the other connecting region 22 in the nature of a hook-and-loop fastener. This connection of the surface structures occurs over the entire surface of the connecting regions 22, so that no openings or gaps remain, which would constitute a leak for an exhaust gas stream loaded with particulates.

Of course, two or more basic elements 20, 20′, 20″ may also be fitted together to form a hollow body 18. They may be provided in the form of flat or slightly bent sheets, for example. The connecting regions 22 of neighboring basic elements only need to overlap and be pressed with one another to obtain the configuration.

It is possible for a plurality of basic elements 20, 20′, 20″ to be fitted to one another in line so that a group of basic elements is produced. The hollow body 18 is wound such that it is given a helically wound, multilayer wall, in which several substrate layers lie one on top of the other (FIGS. 3 and 8). The individual connecting regions 22 preferably lie on each other at one point, but they could also be arranged offset in relation to each other along the periphery of the hollow body 18 (see FIG. 8).

The basic elements 20, 20′, 20″ may have different porosities, so that the individual layers in the wall of the hollow body 18 develop different filter effects. The porosity may however also be selected to be the same for all basic elements 20, 20′, 20″.

The individual basic elements 20, 20′, 20″ may be selectively coated or uncoated, with a coating in sections, as is described above, also being possible.

The last connecting region 22 of the outermost basic element 20″ is pressed with another connecting region 22 of the same or of an adjoining basic element such that the outer periphery of the hollow body 18 does not have a gap or step. The inside of the hollow body 18 is also formed as an even surface without a gap or step (that is, only with the natural roughness of the substrate).

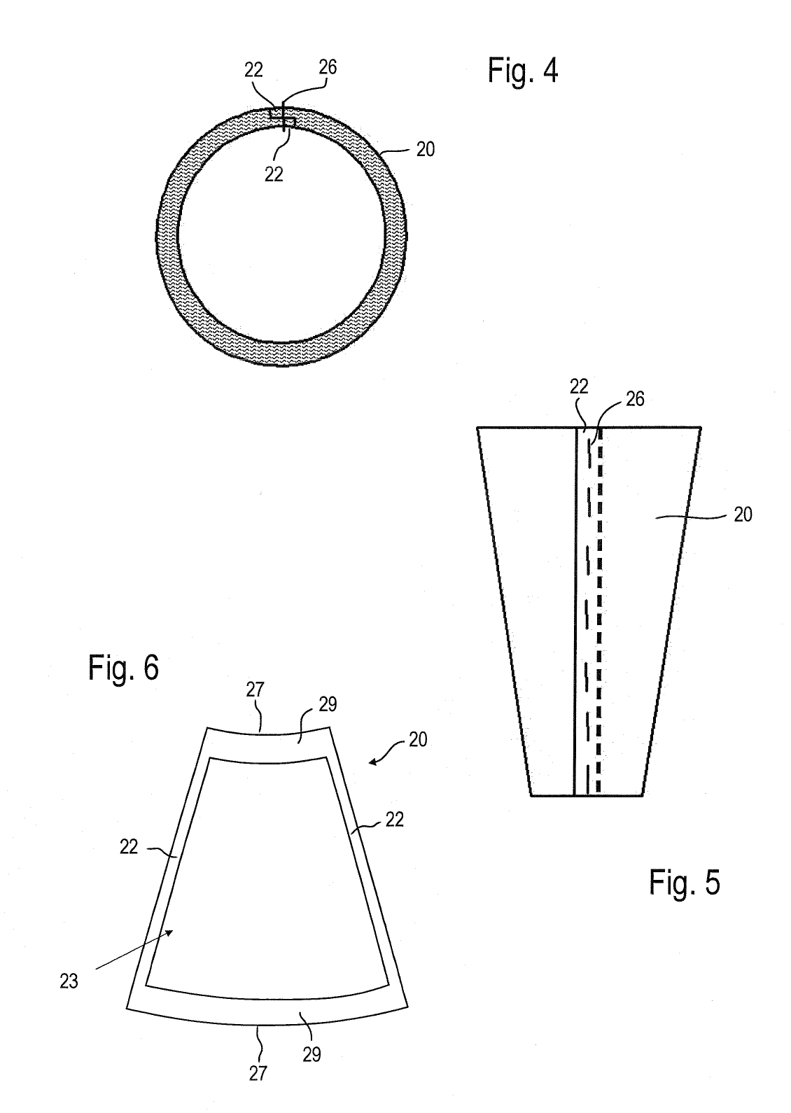

The connected connecting regions 22 may be additionally secured by a further attachment 26, which may be formed, e.g., by clamps or seams. A metal wire is preferably used for the seam. This is illustrated in FIGS. 4 and 5.

A second hollow body 18 is now produced for the exhaust gas treatment device 10 shown in FIG. 1. To this end, a second basic element 20 or a second group of basic elements 20, 20′, 20″ is cut to size, this time in the form of an unrolled cone envelope, which is rolled up to form a cone, with the connecting regions 22 being again placed on top of each other at the straight edges so as to overlap, and being pressed with each other. The cone is then inserted into the truncated cone in accordance with the illustration in FIG. 1, and the hollow bodies 18 are fastened inside the housing 12.

For fastening purposes, the two ends 27 of the cone and of the truncated cone, respectively, are fastened to a frame 24 arranged in the housing 12. The frame 24 is preferably made of a sturdy metal sheet. The hollow body 18 may be fastened to the frame 24 in any suitable manner. One possibility is to design the surface of the frame 24 in such a way that the rough metal foam of the hollow body 18 can get caught therein analogously to the connection of the connecting regions 22 of the basic elements 20, e.g. by providing an appropriately rough surface.

Before or during the process of fastening the hollow bodies 18 to the housing 12, they are calibrated to the exact dimensions of the fastening to the frame 24.

Rather than a truncated cone, other suitable shapes such as, e.g., a cylinder, may, of course, also be manufactured using the technique according to the invention. In particular, the outer hollow body 18 in FIG. 1 could be a cylinder.

Although an embodiment of this invention has been disclosed, a worker of ordinary skill in this art would recognize that certain modifications would come within the scope of this invention. For that reason, the following claims should be studied to determine the true scope and content of this invention.

1. An exhaust gas treatment device for an exhaust system comprising:
a housing with includes an inlet and an outlet; and
at least one hollow body which is configured to be gas permeable and is arranged in a flow path from the inlet to the outlet and which is formed of at least one basic element made from a porous substrate, each basic element including at least two connecting regions wherein two connecting regions, each of one or different basic elements, overlap in a region of a connection to form the at least one hollow body.

2. The exhaust gas treatment device according to claim 1, wherein the connecting regions are pressed and are connected with each other by surface structures of the porous substrate of the respective connecting regions engaging each other.

3. The exhaust gas treatment device according to claim 1, wherein the porous substrate is a metal foam, a metal sponge, a hollow spherical structure, or a fiber mat.

4. The exhaust gas treatment device according to claim 1, wherein the hollow body includes a helically wound multilayer wall.

5. The exhaust gas treatment device according to claim 2, wherein the two connecting regions are fixed to each other exclusively by the surface structures of the porous substrate of the basic element or elements engaging each other.

6. The exhaust gas treatment device according to claim 1, wherein the two connecting regions are fixed to each other by clamping or sewing.

7. The exhaust gas treatment device according to claim 1, wherein the hollow body includes a basic element or group of basic elements bent to form a cylinder, cone, or truncated cone.

8. The exhaust gas treatment device according to claim 1, wherein the basic element has a thickness of approx. 1-10 mm.

9. The exhaust gas treatment device according to claim 1, wherein the hollow body is fixed to a frame arranged in the housing by an interaction of a structure of the porous substrate with a surface of the frame.

10. A method of manufacturing an exhaust gas treatment device, comprising the steps of:
(a) providing at least one basic element made from a porous substrate, each basic element including at least two connecting regions;
(b) superposing two connecting regions, to be connected, of one or more basic elements; and
(c) pressing the two connecting regions, to be connected, with each other to form a hollow body.

11. The method according to claim 10, wherein during pressing, surface structures of the porous substrate of two respective connecting regions get caught in each other.

12. The method according to claim 10, including fixing the two connecting regions to each other by clamping or sewing.

13. The method according to claim 10, including cutting a basic element or a group of basic elements size in the shape of a developed cone envelope or developed truncated cone envelope;
rolling the developed cone envelope or developed truncated cone envelope up to form a cone or truncated cone, so that connecting regions of the rolling the developed cone envelope or developed truncated cone envelope overlap; and
pressing the overlapping connecting regions.
